(19) United States
(12) Patent Application Publication
(10) Pub. No.: US 2006/0229410 A1
(43) Pub. Date: Oct. 12, 2006

(54) GIM environmental protection brightstone granules masterbatch

(76) Inventor: Shih-Chieh Wang, Taipei (TW)

Correspondence Address: Shih-Chieh Wang, P.O. Box No. 6-57, Junghe, Taipei 235, TW

(21) Appl. No.: 11/094,169

(22) Filed: Mar. 31, 2005

(51) Int. Cl. B29B 9/00; C08K 3/00

(52) U.S. Cl. 524/787; 264/13

(57) ABSTRACT

A GIM environmental protection brightstone granules masterbatch, compounded from over 85% calcium carbonate (CaCO₃), with the addition of 13% polypropylene (PP) or polyethylene (PE), and further addition of 2% composite assisting agents, including an aluminate coupling agent (OLAT), stearic acid (HST), ethylene stearamide macromolecular wax (NE3) containing free radical iron ions (PDC), high melting point wax (NE3), vegetable oil and edible ethanol, which are mixed according to set proportions, whereafter they are uniformly blended by means of a high speed mixer, and white granules are extruded at high temperature through a double screw press, which can be used as a plastic-use degradation agent and as a filler.

### BACKGROUND OF THE INVENTION

(a) Field of the Invention

The present invention relates to a compound agent compounded from acidic, fatty and volatile substances. After adding of resin and calcium carbonate in appropriate proportions, the compound agent can not only be used as a filler for plastic manufactured articles, moreover, enables achieving functionality to quickly decompose disposable plastic products after disposal, thereby achieving a new degradable masterbatch that can also act as a filler.

(b) Description of the Prior Art

The present invention relates to a compound agent that uses photosynthesis, oxygenation, evaporation and bacterial degradation to break polyolefin macromolecular bonds and bring about degradation, thereby preventing plastic products from further polluting the environment, thereby achieving objective of environmental protection. Such a degradation masterbatch can be further mixed with a composite of the polyolefin and calcium carbonate, thereby increasing its material properties, and reducing costs, which realizes a new invention that surpasses similar products on the market.

The majority of conventionally manufactured plastic-use filler masterbatches are compounded from calcium carbonate+polyolefin+assisting agents (polyethylene wax, titanium white powder, zinc stearic acid), with the addition of a coupling agent for activating treatment. Although it is claimed that 80% calcium carbonate can be blended in the masterbatch, however, when manufacturing a product, proportion of the masterbatch added is very low, being less than 30%, and, moreover, has a very high degree of brittleness, inadequate resilience, and is unable to realize degradation of disposable products.

Hence, current manufactured plastic-use masterbatches using calcium carbonate as an additive are specifically limited to use in paper, disposable dining utensils, a portion of refuse bags, packing bags, and so on, emphasis being placed on incineration of the refuse after use, and reduction in poisonous waste gases produced by resin. However, the masterbatches are unable to act as a filler for general products made from polypropylene (PP) and polyethylene (PE), moreover, incineration cannot be discontinued, and burying or stockpiling of plastic products in order to achieve effectiveness of natural degradation is incomparable to effectiveness of the GIM degradation masterbatch of the present invention.

The method of mixing calcium carbonate+polyolefin+assisting agents to act as a filler masterbatch for polyolefin products has a development history of over 20 years. Although recent years have seen adoption of coupling agent for activating treatment, with some factories using a high dosage of 2.5% coupling agent added in two batches, and, when used in conjunction with mechanical technological advancements, has enabled Increasing quantities of calcium carbonate, polyolefin and the assisting agents added to the masterbatch to 80%, 14% and 6% respectively. However, shortcomings include the excessive addition of the coupling agent, increase in costs, and length of activating treatment time is 20 minutes, thereby reducing production output, moreover, the 6% proportion of assisting agents is too high, which greatly increases costs. Moreover, contents of the assisting agents are still the same three chemicals as used previously, that is, polyethylene wax, titanium white powder and zinc stearic acid. Such a formulated compound enables adding 80% calcium carbonate to the masterbatch. However, when manufacturing a product, it is difficult to add more than 30% of such a masterbatch because of inability to overcome degree of brittleness resulting from the calcium carbonate, and if over 30% of the masterbatch containing 80% calcium carbonate is added, material properties of certain manufactured products will be forfeited, for instance, easily breakable, and, because the activating treatment takes a time-consuming 20 minutes, production output is reduced. Excessive addition of the assisting agents also increases costs, thus, the conventional masterbatch compounded from a plasticizer, a lubricant, a dispersion medium and a coupling agent is of high cost, moreover, is limited to manufacturing blow membrane or blow molding products, which, thus, narrows its use, and restricts development of the conventional masterbatch.

Hence, a primary objective of the present invention is to achieve compete degradation of disposed plastic products, and realize advancement and enhancement in functionality of a resin filler masterbatch by not only increasing amount of the calcium carbonate added to the masterbatch to over 85%, moreover, when manufacturing plastic products, proportion of the masterbatch added can be as high as 30%-80%, without affecting original material properties of the manufactured product, and break through range of use of similar masterbatches, thereby enabling expansion into the field of light industries, including use in bottles and cans, water pails, aluminum compound boards, planks, trays, tool boxes, fencing, and so on.

### SUMMARY OF THE INVENTION

GIM environmental protection brightstone granules of the present invention are compounded from over 85% calcium carbonate (CaCO₃), with the addition of 13% polypropylene (PP) or polyethylene (PE), and further addition of 2% composite assisting agents, including an aluminate coupling agent (OLAT), stearic acid (HST), ethylene stearamide macromolecular wax (NE3) containing free radical iron ions (PDC), high melting point wax (NE3), vegetable oil and edible ethanol. The aforementioned chemicals are mixed according to set proportions, whereafter they are uniformly blended by means of a high speed mixer, and white granules are extruded at high temperature through a double screw press, thereby producing the GIM environmental protection brightstone granules, which can be used as a plastic-use degradation agent and as a filler.

One function of adding the 2% composite assisting agent to the masterbatch of GIM environmental protection brightstone granules is to enable kneading together a large quantity of inorganic calcium carbonate and a small quantity of organic plastic granules, which thereby enables forming a distinctively new masterbatch. When the GIM masterbatch is mixed with pure plastic polypropylene (PP) or polyethylene (PE) in 3:7 or 8:2 proportions to manufacture a product, a large quantity of calcium carbonate can be successfully added to the plastic product, thereby producing an inexpensive filler. Furthermore, because the 2% composite assisting agent of the GIM contains iron ions that help realize catabolism, vegetable oil and ethanol, thus, the PP or PE molecular bonds can be easily broken within a requested time frame by increasing or decreasing proportions of such, thereby realizing integrated photosynthesis, oxygenation, transpiration and bacterial degradation that achieves the objective of ultimate degradation. Hence, the GIM environmental protection brightstone granules so produced is a degradable masterbatch, which can also function as a filler.

Biodegradability is established through adding the ethylene stearamide (EBS), which acts as a molecular barrier, to the GIM composite assisting agent, and the further addition of the degradation agent containing free radical iron ions (PDC), ethanol and vegetable oil further provides the GIM masterbatch with light and oxygen degradation ability, thereby achieving objective of thorough environmental protection.

The present invention uses an aluminate coupling agent to realize activating treatment of the calcium carbonate, with the further addition of 30% aluminum powder to the original coupling agent, which can be reduced to 0.5%-1%. However, activation technology adopts a batching method whereby the coupling agent is added in three batches, thereby achieving an over 99% cladding rate of the calcium carbonate. A small amount of flexible plastic (SBS) is further added to enhance elasticity, and provide a large quantity of calcium carbonate with resilience, which is not easily breakable. Hence, over 85% of calcium carbonate can be easily mixed with less than 15% resin, which shortens activating treatment time to seven minutes, thereby accelerating manufacture and naturally increasing production output and correspondingly reducing selling price. Thus, degradation effectiveness of the present invention, and its ability to act as a mass filler masterbatch for plastic products assuredly substantiates the present invention as an inexpensive, high quality new invention.

### DETAILED DESCRIPTION OF THE PREFERRED EMBODIMENTS

Manufacture of GIM environmental protection brightstone masterbatch granules needs a formulation of different raw materials in conjunction with a specific technological production process.

The raw material formulation depends on properties required of the finished manufactured article. If the manufactured article is a polypropylene-based (PP) product, then polypropylene (PP) is chosen for a polyolefin portion of the GIM raw material formulation. If the manufactured article is a polyethylene-based (PE) product, then polyethylene (PE) is chosen as the polyolefin portion of the GIM raw material formulation.

The degradable raw material formulation is as follows:
Polypropylene-based product: Use 200-1000 measures of calcium carbonate, making up 85% of the raw material.
Use polypropylene (PP) powder, making up 13% of the raw material. Aluminate coupling agent (with further addition of 30% aluminum powder), making up 0.5%-1% of the raw material.
Polyethylene pyrolysis high melting point wax, making up 0.1% of the raw material.
Polypropylene pyrolysis macromolecular wax, making up 0.5% of the raw material.
Stearic acid, making up 0.2%-0.5% of the raw material. degradation agent containing free radical iron ions, making up 0.5% of the raw material.
Ethylene stearamide, making up 0.3% of the raw material.
Vegetable oil, making up 0.5% of the raw material.
Ethanol, making up 0.5% of the raw material.
   (If there is no need for degradation, then the vegetable oil and the ethanol can be removed from the above formulation.)
Polyethylene-based product: Use 1000-2000 measures of calcium carbonate, making up 85% of the raw material.
Use linear low density polyethylene (PE), making up 13% of the raw material.
Aluminate coupling agent (with further addition of 30% aluminum powder), making up 0.5%-1% of the raw material.
Polyethylene macromolecular pyrolysis high melting point wax. making up 0.35% of the raw material.
Stearic acid, making up 0.5%-1% of the raw material.
Degradation agent containing free radical iron ions, making up 0.5% of the raw material.
Vegetable oil, making up 0.5% of the raw material.
Ethanol, making up 0.5% of the raw material.
   (If there is no need for degradation, then the vegetable oil and the ethanol can be removed from the above formulation.)

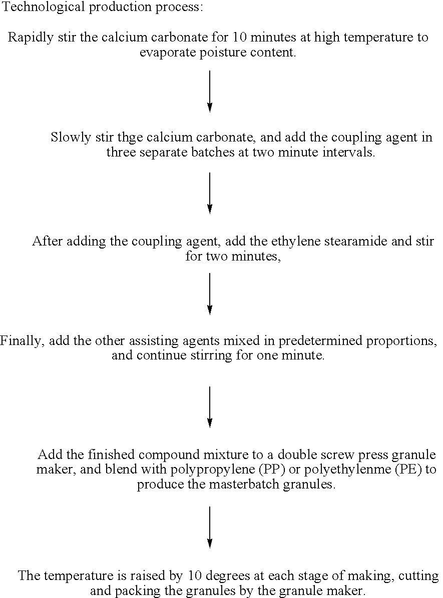

The degradable product manufactured from polypropylene or polyethylene with the addition of the GIM masterbatch produced from the aforementioned production process has extensive use in articles produced by blowing membrane, blowing bottles, streamline molding, suction molding, injection molding, and so on.

Furthermore, with additional proportioning, 30%-80% of the masterbatch can be freely added depending on requirements of material properties of the manufactured product. Hence, the masterbatch has application as an optimum filler that realizes saving on oil resources. Moreover, the masterbatch enables free control over whether or not degradation is required of the product, and length of time needed for degradation.

In addition, experimentation has shown that the manufactured filler masterbatch, biodegradable membranes, dining utensils, and other semi-manufactured or finished products not only increase productivity, which substantially reduces manufacturing costs, moreover, testifies benefit of the masterbatch to environment protection. The China State Chemical Building Material Test Center was especially commissioned to carry out tests on the aforementioned finished or semi-manufactured products, and data from respective test reports (detailed in appendix) on results of the tests reveals that products derived from the present invention contribute substantively to environmental protection.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A method for manufacturing degradable, filler environmental protection brightstone granules (GIM), characterized in that environmental protection brightstone granules (GIM) are compounded from over 85% calcium carbonate (CaCO₃), with the addition of 13% polypropylene (PP) or polyethylene (PE), and further addition of 2% composite assisting agents, which are mixed according to set proportions, whereafter they are uniformly blended by means of a high speed mixer, and white granules are extruded at high temperature through a double screw press, thereby producing the environmental protection brightstone granules (GIM), which can be used as a plastic-use degradation agent and as a filler.

2. The method for manufacturing degradable, filler environmental protection brightstone granules (GIM) as described in claim 1, wherein the composite assisting agents comprise an aluminate coupling agent (OLAT), stearic acid (HST), ethylene stearamide macromolecular wax (NE3) containing free radical iron ions (PDC), high melting point wax (NE3), vegetable oil and edible ethanol.

3. The method for manufacturing degradable, filler environmental protection brightstone granules (GIM) as described in claim 1, wherein the coupling agent adopted is the aluminate coupling agent, with a further addition of 30% aluminum powder to the original coupling agent, which can be reduced to 0.5%-1%, and activation technology adopts a batching method whereby the coupling agent is added in three batches, thereby achieving an over 99% cladding rate of the calcium carbonate, and a small amount of flexible plastic (SBS) is further added to enhance elasticity.

4. The method for manufacturing degradable, filler environmental protection brightstone granules (GIM) as described in claim 2, wherein the coupling agent adopted is the aluminate coupling agent, with a further addition of 30% aluminum powder to the original coupling agent, which can be reduced to 0.5%-1%, and activation technology adopts a batching method whereby the coupling agent is added in three batches, thereby achieving an over 99% cladding rate of the calcium carbonate, and a small amount of flexible plastic (SBS) is further added to enhance elasticity.
